(19) United States
(12) Patent Application Publication
(10) Pub. No.: US 2007/0101608 A1
(43) Pub. Date: May 10, 2007

(54) Apparatus for the treatment of wood or wood products

(76) Inventor: Göran Sundholm, Tuusula (FI)

Correspondence Address: LADAS & PARRY, 26 WEST 61ST STREET, NEW YORK, NY, 10023, US

(21) Appl. No.: 10/579,701

(22) PCT Filed: Nov. 18, 2004
(86) PCT No.: PCT/FI04/00697

§ 371 Date: May 19, 2006

(30) Foreign Application Priority Data
Nov. 21, 2003 (FI) 20031696

(51) Int. Cl. D21J 3/00; F26B 5/14

(52) U.S. Cl. 34/397; 162/396

(57) ABSTRACT

An apparatus for the treatment of wood or wood products, said apparatus comprising at least two treating elements between which moist wood or wood products are treated in conjunction with a drying or pressing process. The treating element (2) at least partly consist of a plurality of tubular parts (7) arranged adjacently to each other, with a groove (8) provided between at least some of the adjacent tubular parts.

### BACKGROUND OF THE INVENTION

The present invention relates to an apparatus for the treatment of wood or wood products as defined in the preamble of claim 1, said apparatus comprising at least two treating elements between which moist wood or wood products are treated in conjunction with a drying or pressing process.

In prior art, apparatus for the treatment of wood and wood products, especially timber, are known in which wood is dried by pressing and simultaneously heating the wood. Press drying is typically performed using a press arranged in a drying chamber. A method of this type is disclosed in specification WO 94/26485. Other press drying arrangements are also known, e.g. from specification FI 97961B. Prior-art treating elements, such as those disclosed e.g. in specification FI 97961B, are surfaces movable relative to each other, on which the timber is placed. The number of these pressing surfaces may vary in different apparatus and it may be e.g. 15-50. In this specification, these surfaces are made from perforated plates and supporting parts placed between them. One of the drawbacks of prior-art solutions is that the moisture evaporating from the wood being dried can not be removed sufficiently well and may get into the air channel between the perforated plates.

The object of the present invention is to create a completely new type of solution for the treatment of wood and wood products that makes it possible to avoid certain drawbacks of prior art. A further object of the invention is to create a solution that facilitates controlled removal of moisture from wood to be dried. Yet another object is to create a solution that can be flexibly varied according to the type or dimensions of the wood material to be treated.

### BRIEF DESCRIPTION OF THE INVENTION

The invention is based on an idea according to which the surface of the treating elements is provided with grooves through which the vaporizing moisture can exit from the wood material in a controlled manner during the drying or press drying process, said grooves being formed at the junction between tubular parts arranged adjacently to each other.

The apparatus of the invention is characterized in that the treating element at least partly consists of a plurality of tubular parts arranged adjacently to each other so that a groove is provided between at least some of the adjacent tubular parts.

The apparatus of the invention is additionally characterized by what is stated in claims 2-11.

The solution of the invention has numerous significant advantages. Providing grooves in the surface of the treating elements enables controlled removal of moisture from the wood material in the apparatus. By using tubular parts arranged adjacently to each other in the treating element, a structure with grooves formed at the junctions between the tubular parts is achieved that can be easily modified according to need. The shape and dimensions of the cross-section of the grooves can be easily varied by using tubular parts having different profiles. By using different spacers between the tubular parts, it is possible to adjust the cross-sectional area of the groove formed between the tubular parts and thus also to adjust the vapor flow. By using tubular parts, grooves are created without machining, thus facilitating the manufacture of the treating elements. By using tubular parts, separate flow passages are formed for a heat transfer medium and the moisture removed from the wood material if desirable. By using lockable treating elements, an advantageous solution is achieved wherein the wood material to be treated can be held under compression even during the drying stage.

### BRIEF DESCRIPTION OF THE FIGURES

In the following, the invention will be described in detail with reference to an example and the attached drawing, wherein

FIG. 1 presents an apparatus according to the invention in a diagram-matic form,

FIG. 2 presents an embodiment of a detail of the apparatus of the invention in a simplified form,

FIG. 3 presents another embodiment of a detail of the apparatus of the invention in a simplified form, and

FIG. 4 presents yet another embodiment of a detail of the apparatus of the invention in a simplified form.

### DETAILED DESCRIPTION OF THE INVENTION

The apparatus of the invention for the treatment of wood or wood products comprises at least two treating elements 2, between which moist wood or wood products 1 are treated in conjunction with a drying or pressing process. At least some of the treating elements 2 have been formed from a plurality of tubular parts 7 arranged adjacently to each other, with a groove 8 provided between at least some of the adjacent tubular parts 7. FIGS. 2-4 present cross-sectional views of different embodiments of the treating element 2. In the embodiments illustrated in FIG. 2-4, grooves 8 have been formed in such manner that they open towards the upper and lower surfaces of the treating elements. Depending on the embodiment, the treating element 2 may have grooves opening only to its upper or lower side.

According to a preferred embodiment, the shape and dimensions of the groove 8 of the treating element 2 depend on the shape of the adjacent tubular parts 7. In the cross-section of the adjacent tubular parts 7, a part of at least one portion forming the wall of the groove 8 has been given a curved shape R. In the embodiments in FIG. 2-4, profiled tubes 7 are used in whose cross-section the corners have a curved shape R. All the corners of each tube in FIG. 2-4 have the same radius of curvature R. It is also possible to use tubular parts that are e.g. round, oval etc. in cross-sectional form, in which case the cross-section does not necessarily have any straight portions at all.

According to a second preferred embodiment, a spacer 12 is provided between at least some of the tubular parts 7 arranged adjacently to each other. The width and/or depth of the groove 8 between adjacent tubes 7 can be varied by means of the spacer 12.

According to an embodiment, adjacent tubular parts 7 are fastened to each other by welding or gluing or soldering or by an equipment method. In the embodiments illustrated in FIG. 2 and 3, adjacent tubular parts are fastened to each other by welds 9.

According to another embodiment, adjacent tubular parts 7 are fastened to each other by means of fastening devices 13. The fastening devices may typically consist of e.g. screws, screw/nut combinations or other applicable fastening devices that can be released if necessary. In the embodiment presented in FIG. 4, adjacent tubular parts are connected to each other by a screw joint, which is represented in the figure in a simplified manner by a dashed line. As shown in the figure, the spacer 12 in this embodiment remains between the tubular parts and a screw 13 preferably goes through the spacer 12. By using different spacers 12, it is possible to influence the width and depth of the groove 8 remaining between the tubes 7. Alternatively, it is possible to use an adjustable spacer.

According to a preferred embodiment, a surface layer 10 comprising apertures is provided between the tubular parts 7 of the treating elements 2 and the wood products 1 to be treated. Thus, the moisture released from the wood can get through the openings into the groove 8, through which the moisture can be passed further.

The heat and the heat transfer medium needed in the treatment process, such as drying and/or pressing process, can be conveyed into the treating elements 2 through the interior space 11 of the tubular parts 7. The heat supplied and on the other hand the moisture removed can be conveyed in the treating elements via channels separate from each other. According to an embodiment, at least some of the tubular parts 7 are provided with apertures 14 formed in the wall of the tubular part, allowing a heat transfer medium or some other medium to be passed from the interior space 11 to the outside of the tubular parts 7.

The apparatus typically comprises a number of treating elements 2 that can be arranged one above the other, the wood or wood products to be treated being placed between each two superimposed treating elements 2 during the drying and/or pressing process. The treating elements 2 can preferably be locked with respect to each other by means of locking devices 6.

The wood or wood products, such as timber 1, is first brought to a assembly station (not shown in the figures). At the assembly station, the timber 1 is packed in the spaces between the treating elements 2. The timber thus packed forms a batch.

The combination consisting of the superimposed treating elements 2 and the timber 1 arranged in the spaces between them is moved into a pressing chamber, where the combination is pressed by means of pressing elements so that the timber 1 is compressed between the treating elements 2. The press bar of the pressing elements is typically moved by means of at least one cylinder-piston combination. In a typical case, the pressing elements press the treating element 2 by its upper surface, the timber to be treated being thus compressed between the treating elements. The bottommost one of the treating elements 2 may be placed e.g. on a base substantially immovable in the pressing direction.

In the pressing chamber, the combination of wood or wood products 1 is compressed until reaching the stoppers 5 defining the height of the pressing spaces, and thus the desired combination of the wood or wood products is achieved and free water is squeezed out of the wood in a quantity that may be as much as 50% of the water content. Typically, about 20-50% of the water content is removed by compressing. The compression pressure used depends on the kind of wood being treated and the thickness of the timber, being typically 5-20 kp/cm². During the pressing stage, the wood may also be heated, in which case, depending on the properties of the wood species being treated, the wood material is softened and the water is removed more readily. During the pressing stage, the aim is to keep the treatment temperature below the boiling point of water. The temperature can be increased during the pressing stage, e.g. 40-80° C. As the wood is softened, the pressing becomes easier and a lower compression pressure can be used if desired. By keeping the temperature below the boiling point of water, heating energy is saved. It is to be noted that the wood material being treated is also heated as a consequence of the compression. The rise of temperature as a consequence of compression varies, depending on the wood species or wood quality etc. In some wood species a considerable rise of temperature occurs as a result of the pressing, and therefore no additional heat may be needed at all or only very little additional heat may be needed during the pressing stage. The pressing can be implemented in a desired manner, by using an even and constant pressure or also e.g. by varying the compression pressure, causing the moisture to be equalized in the wood material being treated. Typically the wood material to be treated reaches a moisture content of 16-20% after the pressing stage.

During the pressing, the water is removed via the grooves formed in the treating elements 2. The grooves may be of different sizes and shapes and their number may vary depending on the embodiment. In one embodiment, the treating elements 2 are provided with channels 11, e.g. for conveying a heating medium through them. The heating medium may be e.g. warm air and/or water vapor obtained from the drying stage.

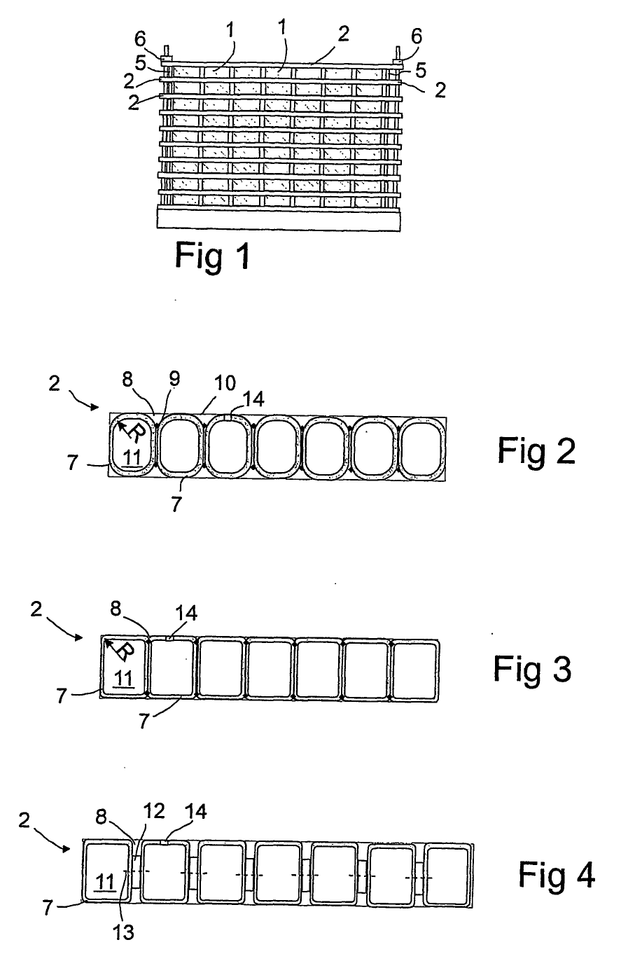

The combination of treating elements 2 and wood or wood products is locked so that the wood or wood products placed in the pressing spaces remain under compression between the treating elements 2. In the locked position, the treating elements 2 are typically moved against the thickness defining stoppers 5. FIG. 1 shows a diagrammatic representation of a combination of treating elements and timber as applied in a method according to the invention, in the locked position. The treating elements are locked by means of locking devices 6 in place, allowing the combination of treating elements and timber to be moved into the drying chamber. The locking devices 6 are typically mechanical locking devices.

Once the desired drying result has been achieved, the batch is moved from the drying chamber into a cooling chamber. In the cooling chamber, the wood material is cooled slowly according to a given program.

The apparatus of the invention can be utilized in a timber drying process and, if desirable, it can also be used in the production of compreg wood.

It is obvious to the person skilled in the art that the invention is not limited to the embodiments described above, but that it may be varied within the scope of the claims presented below. Features that may have been presented together with other features in the description can also be used separately from each other if necessary.

1. An apparatus for the treatment of wood or wood products, said apparatus comprising at least two treating elements between which moist wood or wood products are treated in conjunction with a drying or pressing process, characterized in that the treating element (2) at least partly consists of a plurality of tubular parts (7) arranged adjacently to each other, with a groove (8) provided between at least some of the adjacent tubular parts.

2. An apparatus according to claim 1, characterized in that the shape and dimensions of the groove (8) depend on the shape of the adjacent tubular parts (7).

3. An apparatus according to claim 1, characterized in that, in the cross-section of one of the adjacent tubular parts (7), at least a part of the portion facing the groove 8 has a curved shape (R).

4. An apparatus according to claim 1, characterized in that a spacer (12) is provided between the tubular parts (7) arranged adjacently to each other.

5. An apparatus according to claim 1, characterized in that the width and/or depth of the groove between adjacent tubes (7) can be varied by means of the spacer (12).

6. An apparatus according to claim 1, characterized in that the apparatus comprises a plurality of treating elements (2) that can be arranged one above the other, the wood or wood products(1) to be treated being placed between each two superimposed treating elements (2).

7. An apparatus according to claim 1, characterized in that the treating elements (2) can be locked with respect to each other by means of locking devices (6).

8. An apparatus according to claim 1, characterized in that a surface layer (10) comprising apertures is provided between the tubular parts (7) of the treating elements (2) and the wood products (1) to be treated.

9. An apparatus according to claim 1, characterized in that adjacent tubular parts (7) are fastened to each other by welding or gluing.

10. An apparatus according to claim 1, characterized in that adjacent tubular parts (7) are fastened to each other by means of fastening devices (13).

11. An apparatus according to claim 1, characterized in that at least some of the tubular parts (7) are provided with apertures (14) formed in the wall of the tubular part.
